(19) United States
(12) Patent Application Publication
(10) Pub. No.: US 2021/0116112 A1
(43) Pub. Date: Apr. 22, 2021

(54) FRAMING SYSTEM FOR LIGHT EMITTING DIODE LINEAR FLUORESCENT LAMP REPLACEMENT

(71) Applicant: CURRENT LIGHTING SOLUTIONS, LLC, East Cleveland, OH (US)

(72) Inventors: Alin Ionut PETRESCU, Montreal (CA); Bruno D'AMICO, Montreal (CA); Barron LEE, Lachine (CA); Robert David SPIVOCK, Lachine (CA); Michel DOSS, Lachine (CA)

(21) Appl. No.: 17/054,615

(22) PCT Filed: Jun. 5, 2019
(86) PCT No.: PCT/US2019/035554

§ 371 Date: Nov. 11, 2020

Related U.S. Application Data
(60) Provisional application No. 62/681,512, filed on Jun. 6, 2018.

(51) Int. Cl. F21V 21/34; F21V 21/22; F21V 19/00

(52) U.S. Cl. CPC F21V 21/34; F21Y 2115/10; F21V 19/0055; F21V 21/22

(57) ABSTRACT

Provided is a support system for replacing a linear fluorescent lamp with a light emitting diode (LED) module. The support system includes an elongated support member having one or more channel structures extending along substantially an entire length of the elongated support member. One or more ends of the elongated support member are configured for engagement with a socket. The support system includes at least one LED module mounted in mechanical engagement with the one or more channel structures by a fastening mechanism. The at least one LED module is positionable along a portion of the length of the channel structure.

### I. TECHNICAL FIELD

The present invention generally relates to light emitting diode (LED) linear fluorescent lamp (LFL) replacement. More specifically, the present invention relates to providing framing systems for LED LFL replacements that provide flexible light density, in convenient signage structures.

### II. BACKGROUND

The popularity of LEDs has created a rapidly expanding new industry in signage as LEDs replace conventional LFLs used in existing signs. Traditional LFL replacement products utilize LED modules and structures that rely largely on securing the LED modules to metal hollow tube extrusions. This arrangement is problematic for several reasons.

For example, the LED modules are secured to the hollow tube extrusions using screws. When the module is screwed into the hollow tube, the holes created by the screws remove material from the tube extrusions, thus compromising the integrity and stability of the tube structure.

Another problem created by using the hollow tube extrusions arises when the LED modules need to be relocated. Relocating the LED modules requires additional holes to be made or drilled into the extrusion, further compromising the structure.

Additionally, LFL signs can vary in height, from around 18 inches up to about 10 feet, or more. As a result, LFL signs can be difficult to manufacture. To accommodate the size requirement, LFLs are typically designed at shorter lengths. Multiple shorter length LFLs are then fused together. LEDs are much easier to manufacture and by introducing an extrusion that can be cut any length makes LED application significantly less complicated.

One additional challenge of hollow tubes is that they do not enable hiding of wiring harnesses.

### III. SUMMARY

Given the aforementioned deficiencies, a need exists for methods and systems that allow LED modules to be screwed into a defined location, such as an elongated support member, without compromising structure. A need also exists for methods and systems that provide a continuous integrated channel within the elongated support member, where the LED modules can be placed or repositioned without compromising system structure.

Embodiments of the present invention provide an LED LFL replacement system including a framing element and an LED light source. The framing element includes a channel feature that permits the LED light source to be secured to the framing element. The replacement system permits a flexible light density and creates lighting structures when structures are combined together. The channel feature provides a location where wiring harnesses can be hidden, providing the harness protection and damage avoidance during application.

Under certain circumstances, embodiments of the present invention provide a support system for a light emitting diode (LED) module. The support system includes an elongated support member having one or more channel structures extending along substantially an entire length of the elongated support member. One or more ends of the elongated support member are configured for engagement with a socket. The support system includes at least one LED module mounted in mechanical engagement with the one or more channel structures by a fastening mechanism. The at least one LED module is positionable along a portion of the length of the channel structure.

The described framing structure has an integrated channel and allows for flexible LED placement. In particular, the integrated channel also allows for multiple framing elements to be connected together permitting easy expansion and creation of additional light structures. Finally, the channel allows for a more discrete place to route the wires to avoid damage in handling or shipping of the assembly.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### IV. BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of conventional LED LFL replacement products.

FIG. 2 is an illustration of additional conventional LED LFL replacement products.

FIG. 3 is an illustration of a retrofit of an example retrofit LED LFL installation.

FIGS. 4A-4D are illustrations of an LED LFL replacement structure constructed in accordance with embodiments of the present invention.

FIG. 5 is an example illustration of an elongated support structure having a continuous channel, in accordance with the embodiments.

FIG. 6 illustrates an example application of the elongated support structure of FIG. 5 in accordance with the embodiments.

FIG. 7 is an illustration of an alternative embodiment of the present invention.

FIG. 8 is an illustration of an additional example application of the embodiments.

FIG. 9 is an illustration of yet an additional example application of embodiments of the present invention.

### V. DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

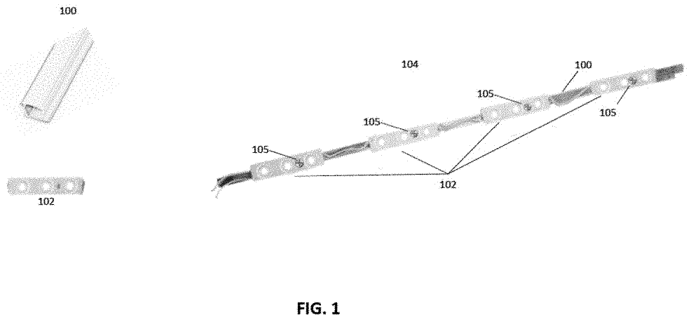

FIG. 1 is an illustration of conventional light emitting diode (LED) linear fluorescent lamp (LFL) replacement products. In FIG. 1, a conventional hollow extruded tube 100 is used for securing an LED module 102 to form an LED strip 104. By way of example, an LED module includes any lighting device using LEDs as its primary source of light. The LED module 102 is typically secured to the hollow extruded tube 100 by small screws 105 that form holes (not shown) in the hollow extruded tube 100. These multiple holes, used to secure multiple LED modules 102, ultimately compromise the structure of the tube 100. The strip 104, including the multiple LED modules 102, can be secured by a socket and used to retrofit an existing LFL sign.

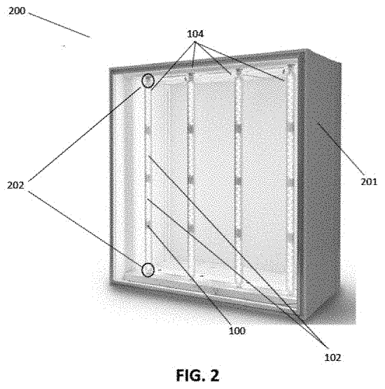

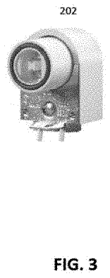

FIG. 2 is an illustration of an example retrofit installation sign 200. The installation 200 includes a cabinet 201 for securing multiple LED modules, such as the LED modules 104 depicted in FIG. 1. Each of the LED modules 104 is formed of multiple LED segments 102 secured to the hollow tube extrusion 100. Each strip is secured to the cabinet 201 via sockets 202, described more fully in FIG. 3.

FIG. 3 is an example illustration of the socket 202 used as double socket ends (i.e., brackets) to secure respective end points of each of the hollow tubes 100. Other conventional installations use different structures, with or without end caps. For example, some manufacturers create their own brackets from sheet metal, or other bracketing material, to secure the end points of the hollow tubes 100. Yet other conventional arrangements can use configurations such as spring-loaded adapters.

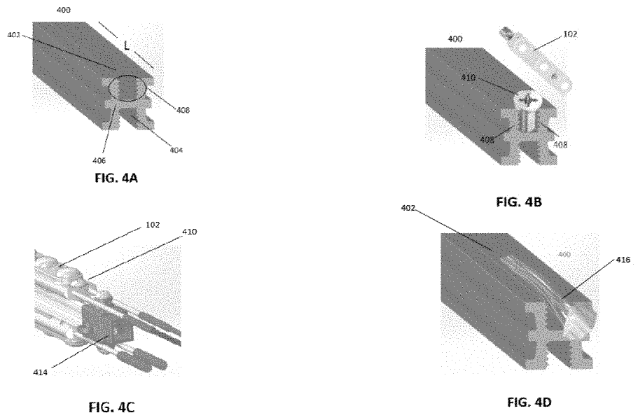

FIG. 4A is an illustration of an LED LFL replacement elongated support member 400 constructed in accordance with embodiments of the present invention. By way of example, the elongated support member 400 can be constructed of any suitable material. Metals, such as aluminum, are among such suitable materials. Unlike the extruded tubes 202 and 302 depicted in FIG. 3, elongated support member 400 is not hollow. Such an arrangement as the elongated support member 400 can be optimal for placement of a light engine.

In FIG. 4A, the elongated support member 400 includes at least a first channel 402 disposed within the elongated support member 400 and extending substantially along its length (L). Also included within the elongated support member 400 is a second channel 404. The channels 402 and 404 are defined by a partition 406 extending therebetween, and also along the length (L). In FIG. 4A, each of the channels 402 and 404 includes one or more threads (e.g., notches) 408.

Structures constructed in accordance with the elongated support member 400 of FIG. 4A provide flexibility in LED module locations in a factory or in the field. This flexibility is provided by moving modules along channels, such as the channels 402 and 404. Multiple framing elements can be used together to create a lighting structure in the factory or in the field. In some embodiments, channels (i.e., channel features) allow for a location to hide and protect wiring harnesses without additional material. In some embodiments, the channels 402 and 404 can also be used to secure other devices beyond light engines or LED modules. For example, the channels 402 and 404 can be used to secure sensors or other devices to the elongated support member 400.

The embodiments are not limited to the channels and threads depicted in FIG. 4A. Any suitable number of channels and ridges or threads can be used and remain within the spirit and scope of the present invention.

In the metallic elongated support member 400 of FIG. 4B, an LED module, such as the LED module 102, can be attached without piercing through the metal structure and creating a new hole that would compromise the structure's integrity. For example, the LED module 102 can be attached to the elongated support member 400 using a fastening mechanism, such as the screw 410, configured for mechanical engagement of the channel structure. In an embodiment, the screw 410 can be fastened via friction by tightening the screw 410 against the threads 408.

As illustrated in FIG. 4C, the LED module 102 can be firmly secured to the elongated support structure 400 by tightening the screw 410 at any point along either of the channels 402 or 404. In this manner, the integrity or stability of the elongated support structure 400 is preserved. In one or more embodiments, the LED module 102 is positionable along a portion of the length of the channel 402. The elongated support member 400 is versatile. For example, individual sections of the structure 400 can be combined with one another via any suitable coupling mechanism, such as a coupler/connector 414, illustrated in the example of FIG. 4C.

An advantage of a continuous channel structure, such as the elongated support member 400, is that the LED modules can be repositioned and moved to any location by simply loosening the screws, such as the screw 410. The modules may even be removed and completely repositioned at a new location. Given the flexibility of this assembly, a user or installer can create a variety of different light densities: for example, creating more density in one area and less density in another area by experimenting with different locations of the LED modules. As illustrated in FIG. 4D, in some embodiments a wiring harness 416 can be hidden and/or protected via placement within one of the channels 402 or 404.

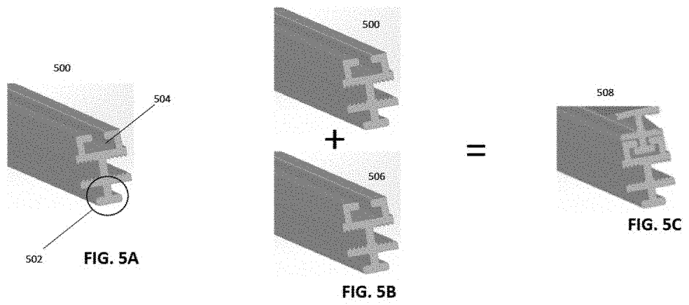

FIG. 5A is an example illustration of an elongated support member 500 having a continuous channel in accordance with an alternative embodiment of the present invention. The elongated support member 500 also includes one or more continuous channels threaded in a manner similar to the structure 400 of FIG. 4. By way of example and not limitation, the elongated support member 500 includes a (T) type protrusion 502 and a (T) slot 504.

The (T) protrusion 502 and the (T) slot 504 enable structures, such as the structure 500, to be combined to form different types of elongated support structures, as depicted in FIG. 5B. For example, two structures, such as the elongated support member 500 and an additional structure 506, can be combined by inserting the (T) protrusion 502 of the structure 500 with the (T) slot 504 of the structure 506. In an alternative embodiment, the (T) protrusion and slots could be positioned on the side, or at some other location, on the elongated support member 500. Additionally, the embodiments are not limited to (T) shapes. Various other shapes, such as a dovetail, for example, would be within the spirit and scope of the present invention.

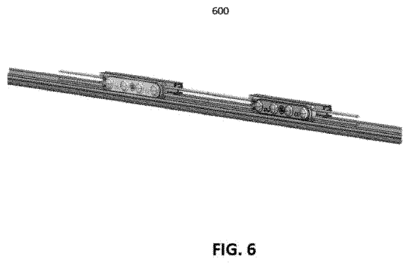

Structures 500 and 506 can lock into position by sliding one over the other to create frictional engagement, in a manner 508 depicted in FIG. 5C. Various other coupling mechanisms would be within the spirit and scope of the present invention. Such a combined structure is illustrated more clearly with the elongated support member channel structure 600 of FIG. 6.

FIG. 6 illustrates an example application of the elongated support structure of FIG. 5 in accordance with the embodiments. Elongated support structure 600 includes a combined structure having a first elongated support member having a protrusion coupled to a slot of a second elongated support member. The first elongated support member further includes two LED modules mounted thereto. In a particular embodiment, the two LED modules are mounted to a channel of the first elongated support member by a fastening mechanism. In a particular embodiment, the fastening mechanism may include a screw, a bolt, or other suitable fastener. In a particular embodiment, the fastening mechanism may be integrated with the LED module. In another particular embodiment, the fastening mechanism may be a separate component from the LED module.

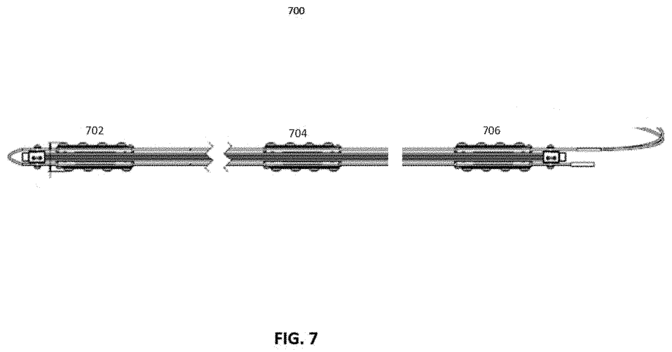

FIG. 7 is an illustration of an alternative embodiment 700 of the present invention. FIG. 7 provides an exemplary illustration of a number of smaller connectable modules 702, 704, and 706. Each of the modules 702, 704, and 706 is an LED module on a section of the elongated support member. In FIG. 7, instead of having an elongated single module, the smaller connectable modules 702, 704, and 706 can be clipped or coupled together. In a particular embodiments, the modules 702, 704, and 706 can be coupled together using a coupler/connector 410, an adapter, or any other suitable connection arrangement or configuration.

For example, the modules 702, 704, and 706 can be connected together using an interconnectable feature. As such, an adapter could be used that connect the modules at different angles, shapes, sizes, and orientations with respect to one another to create even greater lighting varieties and densities. By way of example, these alternative arrangements could include non-parallel configurations.

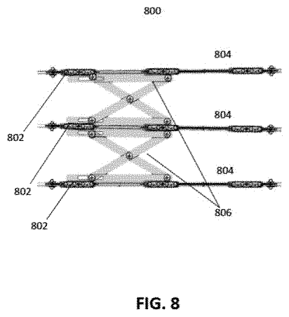

FIG. 8 is an illustration of an additional example application 800 of embodiments of the present invention. In FIG. 8, various adapters (not shown) known to those of skill in the art can be used to connect LED modules 802 to extruded metal structures 804 to an accordion, or bello-like, device 806. Such an arrangement would permit the device to collapse on itself into a plurality of bars during shipment. During unpacking, the device will open up or expand. Another feature the accordion or bello-like device 806 is that it enables varying the intensity of light on a given surface by expanding the structure to the desired light density.

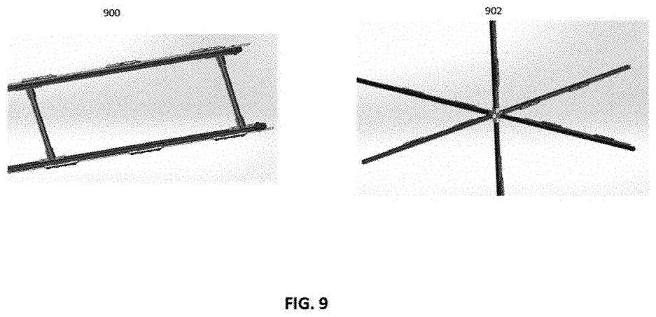

FIG. 9 is an illustration of yet an additional example application 900 of embodiments of the present invention. In FIG. 9, elongated support member continuous channel structures, such as the structure 400, can be used in various 2-dimensional 900 and 3-dimensional 902 configurations by being coupled together by suitable connectors. For example, two channel structures of 2-dimensional configuration 900 may be coupled together using one or more T-shaped right-angle connectors and the two channel structures may be disposed parallel to one another. In the illustrated embodiment, each of the channel structures includes three LED modules coupled thereto such that the LED modules of one channel structure are disposed in an opposite directions with respect to the LED modules of the other channel structure.

In another example, an end of each of six channel structures of 3-dimensional configuration 902 may be coupled together using a single connector such that an end of each of four of the channel structures are coupled at right angle to one another and are disposed within a first plane, and an end of each of the remaining two channel structures are coupled to together and disposed in a second plane. In the illustrated embodiment, the first plane is perpendicular to the second plane. In the illustrated embodiment, each of the six channel structures includes two LED modules mounted thereto.

The detailed description is not meant to be limited in its scope of disclosure. Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A support system for a light emitting diode (LED) module, comprising:
an elongated support member having one or more channel structures extending along substantially an entire length of the elongated support member, wherein one or more ends of the elongated support member are configured for engagement with a socket; and
at least one LED module mounted in mechanical engagement with the one or more channel structures by a fastening mechanism, the at least one LED module being positionable along a portion of the length of the channel structure.

2. The support system of claim 1, wherein the one or more channel structures are continuous.

3. The support system of claim 1, wherein the one or more channel structures include one or more notches.

4. The support system of claim 3, wherein the notches are threads.

5. The support system of claim 1, wherein the elongated support system is configured for coupling to another elongated support member.

6. The support system of claim 5, wherein the coupling occurs via slidable engagement.

7. The support system of claim 1, wherein sections of the elongated support member are modular, each modular section is configured for coupling to one LED module.

8. The support system of claim 1, further comprising an end cap coupled to the elongated support member.

9. The support system of claim 1, wherein the fastening mechanism includes one or more fasteners.

10. The support system of claim 1, wherein the one or more fasteners includes at last one of a screw or a bolt.

11. The support system of claim 1, wherein the fastening mechanism is configured to allow the at least one LED module to be repositioned along the length of the channel structure.

12. The support system of claim 1, wherein the one or more channel structures are configured to allow a wiring harness to be disposed therein.

13. The support system of claim 1, wherein one or more LED modules are secured to the channel structure with a slide engagement.

14. The support system of claim 1, wherein the one or more channel structures includes a first channel structure and a second channel structure separated by a partition.

15. The support system of claim 1, wherein the elongated support member further includes a protrusion configured for engagement with another elongated support member.

16. The support system of claim 1, wherein the protrusion is T-shaped.

17. An apparatus, comprising:
an elongated support member having one or more channel structures extending along substantially an entire length of the elongated support member, wherein one or more ends of the elongated support member are configured for engagement with a socket; and
at least one LED module mounted in mechanical engagement with the one or more channel structures by a fastening mechanism, the at least one LED module being positionable along a portion of the length of the channel structure.

18. The apparatus of claim 17, wherein the one or more channel structures are continuous.

19. The apparatus of claim 17, wherein the one or more channel structures include one or more notches.

20. The apparatus of claim 19, wherein the notches are threads.
